(19) United States
(12) Patent Application Publication
(10) Pub. No.: US 2009/0038383 A1
(43) Pub. Date: Feb. 12, 2009

(54) PHOTOMASK DEFECT CORRECTION DEVICE AND PHOTOMASK DEFECT CORRECTION METHOD

(76) Inventors: Takuya Nakaue, Chiba-shi (JP); Atsushi Uemoto, Chiba-shi (JP); Osamu Takaoka, Chiba-shi (JP)

Correspondence Address: BRINKS HOFER GILSON & LIONE, P.O. BOX 10395, CHICAGO, IL, 60610, US

(21) Appl. No.: 12/145,952

(22) Filed: Jun. 25, 2008

(30) Foreign Application Priority Data
Jun. 25, 2007 (JP) JP2007-165983

(51) Int. Cl. G01B 5/28

(52) U.S. Cl. 73/105

(57) ABSTRACT

Provided is a photomask defect correction method including: an observing step of scanning plurality of lines one after another while controlling a distance between the probe tip and a surface (2a) of the substrate so that displacement of the probe becomes constant to recognize a shape of the defect portion (5) through AFM observation; and a processing step of scanning a plurality of lines one after another while pressing the probe tip to the recognized defect portion with a predetermined force to subject the defect portion to cutting and removing processing, in which, at the observing step, the scanning for every one line is set in a parallel direction (C direction) to an edge (3a) of a mask pattern (3), and the scanning of the plurality of lines is performed one after another from the mask pattern side towards a tip side (D direction) of the defect portion.

### RELATED APPLICATION

This application claims priority under 35 U.S.C. §119 to Japanese Patent Application No. JP2007-165983 filed on Jun. 25, 2007, the entire content of which is hereby incorporated by reference.

### BACKGROUND OF THE INVENTION

1. Field of Invention

The present invention relates to a photomask defect correction device and a photomask defect correction method involving subjecting a defect portion of a photomask, which is used when manufacturing a semiconductor, to cutting and removing processing to correct the photomask into a normal one.

2. Description of the Related Art

The photomask, which is used when manufacturing a semiconductor, becomes an original plate for a pattern, and hence after drawing a mask pattern on a mask substrate, an inspection of presence or absence of the defect portion is always conducted, and the correction of the defect portion is optionally carried out.

The photomask is drawn on the mask substrate with a drawing device based on drawing data designed in advance. With this, the photomask having a mask pattern drawn on the mask substrate is prepared. Further, after preparing the photomask, the presence or absence of the defect and location of the defect portions are inspected using a defect inspection device, and if any defect is present, defect correction processing with a photomask defect correction device is carried out before the photomask is transferred onto a wafer.

As the kinds of the defect of the mask pattern, for example, a projection which excessively projects from a desired pattern and becomes the projection, a recess such as a cutaway is caused in the desired pattern (intrusion), and the like are given. Those defect portions are corrected as follows. After the location of the defect portion is identified by the defect inspection device, the shape of the defect portion is recognized in detail by the photomask defect correction device and also removing processing is conducted with respect to the defect which becomes a projection, and about pattern lacking, a light-blocking film is formed on the recess portion to be corrected.

As methods of removing processing at this time, there are known various methods. However, as one of those, there is known a method involving using an atomic force microscope (AFM) to correct the defect portion (see, “Defect repair performance using the nanomachining repair technique,” 2003, Proc. of SPIE 5130, P520-P527, written by Y Morikawa, H. Kokubo, M. Nishiguchi, N. Hayashi, R. White, R. Bozak, and L. Trrill).

This method involves observing a predetermined area on the mask substrate with a probe having a probe tip at a tip thereof using AFM to specify in detail the defect portions of the mask pattern, and then the defect portions are subjected to the cutting and removing processing using the same probe. In particular, this method is effective in a case where the defect portions excessively protrude from a desired pattern to form projection-like shapes.

Detailed description is made of this method with reference to FIG. 12. Note that, FIG. 12 illustrates a mask pattern 31 drawn on a substrate 30, and is viewed from upward thereof, in which a projection type defect portion 32 locates on the mask pattern 31.

At first, existence of the defect portion 32 on the mask pattern 31 is confirmed in advance with a defect inspection device, and a position of the defect portion 32 is specified. Then, before conducting the correction with the photomask defect correction device, periphery of the defect portion 32 are set as an observation area E based on the positional data.

If the observation area E is specified, the photomask defect correction device scans the probe within the observation area E. Specifically, the scanning is performed while a distance between the probe tip and the mask substrate 30 is height-controlled so that the bending of the probe becomes constant. In this case, the scanning is performed in a direction parallel to the mask pattern 31 (arrow A1 direction), and the scanning is repeatedly performed multiple times from a tip side of the defect portion 32 towards a root side (mask pattern 31 side) (towards arrow A2 direction). With this operation, surface observation of the mask substrate 30 within the observation area E may be made, and images of a part and the defect portion 32 of the mask pattern 31 is acquired to extract a contour line of a straight line pattern without defect from the images through image processing, and assume the contour line of the defect portion 32 from the extracted contour line, and recognize an excessive portion outside the assumed contour line as the defect.

Subsequently, after the recognition of the defect portion 32 by the above-mentioned method, the scanning is performed while pressing the probe to the defect portion 32 with a predetermined force. With this operation, by using a harder probe tip than a material to be processed (defect portion), it is possible to cut the recognized defect portion 32 with mechanical processing. Then, by repeatedly performing the scanning at multiple times, the entire defect portion 32 may be subjected to the cutting and removing processing to remove the defect portion 32.

Specifically, the probe is scanned in a parallel direction to the mask pattern 31 (arrow A1 direction) to cut the defect portion 32 in a line shape, and the scanning is repeatedly performed at multiple times from the tip of the defect portion 32 towards the root side of the defect portion 32 (towards arrow A2 direction), the entire defect portion 32 may be subjected to the cutting and removing processing.

The reason why the cutting is performed in the above-mentioned direction (arrow A2 direction) is to reduce cutting resistance as much as possible. If the cutting and removing processing is performed from the root side towards the tip side (opposite direction to arrow A2 direction), there is a fear of being not able to cut well due to large cutting resistance. In particular, as described above, the photomask becomes an original plate of the pattern, and when subjecting the defect portion 32 to the cutting and removing processing, processing with high precision is required. For that reason, the cutting and removing processing is performed in the above-mentioned direction. As those results, the projection type defect portion 32 may be removed to correct the mask pattern 31 into a correct one.

However, in the above-mentioned conventional method, the following problems are remained unsolved.

At first, for the probe tip provided to the tip of the probe, a hard material (diamond, etc.) is employed for cutting and removing processing the defect portion 32. Therefore, at the time of AFM observation, as illustrated in FIG. 13, there was a case where a part of the defect portion 32 is scooped by the probe tip 33. In particular, the scoop is liable to cause at a portion where the probe tip 33 runs up the defect portion 32. Moreover, the scooped portion attaches to the probe tip 33 as it is, and becomes a mere foreign matter X, hereinafter.

Like this, during the observation, if the foreign matter X once attaches to the vicinity of the probe tip, the observation must be performed with the probe tip 33 as it stands to which the foreign matter X adheres. Accordingly, from both the tip of the probe tip and the foreign matter X interatomic forces are detected and forms double image which is convoluted with both the interatomic forces (hereinafter, referred to as double chip image), thereby being not possible to obtain a correct image. Moreover, there is such a risk that the defect portion 32 is scooped again due to the foreign matter X attached before, and as shown in FIG. 14, there is a fear of being newly attached with another foreign matter X.

As described above, there was a case of being not possible to obtain a normal image due to the influence of the foreign matter attached to the probe tip 33. In particular, there is not much influence for the first observation, but in the case of performing the processing after the observation of multiple times, it is likely to cause a double chip image.

In this case, in the conventional method, the direction for repeating the scanning at the time of the observation is from the tip side of the defect portion 32 towards the root side being the mask pattern 31 side (towards arrow A2 direction), and therefore, as shown in FIG. 15, the image in the periphery of the root of the defect portion 32 becomes a double chip image. For that reason, the contour in the vicinity of the root side of the defect portion 32 or the edge shape of the mask pattern 31 may not sometime be recognized correctly. Specifically, the edge portion is blurred to be unclear or double, thereby being not able to obtain clear image.

In particular, it is not possible to correctly recognize the edge shape of the mask pattern 31, thereby being difficult to distinguish between the mask pattern 31 and the defect portion 32. For that reason, not only the defect portion 32 may not be removed with high accuracy by the cutting and removing processing, but also have a fear of cutting the mask pattern 31. On the contrary, because the mask pattern 31 and the defect portion 32 may not be clearly distinguished therebetween, if the defect portion 32 is largely left uncut, additional processing is required, resulting in degradation of the working efficiency.

### SUMMARY OF THE INVENTION

The present invention has been made in view of the above-mentioned circumstances, and has an object to provide a photomask defect correction device and a photomask defect correction method with which it is possible to correctly obtain an image in a periphery on a root side of a defect portion without receiving an influence of a double chip image to recognize the defect portion and the mask pattern with clearly distinguished state, and is possible to remove the defect portion with high accuracy by means of cutting and removing processing.

In order to attain the above-mentioned object of the invention, the present invention provides the following means.

According to the present invention, there is provided a photomask defect correction device for correcting a defect on a photomask including a substrate and a mask pattern formed on the substrate with a predetermined pattern through AFM observation of the photomask to recognize a shape of a projection type defect portion projected from the mask pattern, and by cutting and removing processing the recognized defect portion,

the photomask defect correction device including:
a stage for fixing the photomask;
a probe having a probe tip provided on a tip of the probe, the probe tip being disposed opposingly to the substrate;
a moving means for relatively moving the substrate and the probe in a parallel direction of a surface of the substrate and in a vertical direction the surface of the substrate;
a displacement measuring means for measuring displacement of the probe; and
a control means for scanning, based on results of measurement by the displacement measuring mean, adjacent plurality of lines one after another so that the displacement of the probe becomes constant, while controlling a distance between the probe tip and a surface of the substrate, recognizing a shape of the defect portion through AFM observation, and for cutting and removing processing the defect portion by scanning the adjacent plurality of lines one after another while pressing the probe tip to the recognized defect portion with a predetermined force, to thereby subject the defect portion to the cutting and removing processing,

in which the control means sets, at the time of observation, the scanning direction for every one line in a parallel direction with respect to an edge of the mask pattern, and controls so that the scanning of the plurality of lines one after another is performed in a direction from the mask pattern side towards a tip side of the defect portion, and

the control means sets, at the time of cutting and removing processing, the scanning direction for the every one line in the parallel direction with respect to the edge of the mask pattern, and controls so that the scanning of the plurality of lines one after another is performed in a direction from the tip of the defect portion towards the mask pattern.

Further, according to the present invention, there is provided a photomask defect correction method of correcting a defect on a photomask including a substrate and a mask pattern formed on the substrate with a predetermined pattern by recognizing a shape of a projection type defect portion projected from the mask pattern through AFM observation of the photomask by using a probe having a probe tip at a tip of the probe and by cutting and removing processing the recognized defect portion using the probe,

the photomask defect correction method including:
an observing step of scanning adjacent plurality of lines one after another while controlling a distance between the probe tip and a surface of the substrate so that displacement of the probe becomes constant to recognize a shape of the defect portion through AFM observation; and
a processing step of, after the observing step, scanning the adjacent plurality of lines one after another while pressing the probe tip to the recognized defect portion with a predetermined force to subject the defect portion to cutting and removing processing,

in which, at the observing step, the scanning for every one line is performed in a parallel direction to an edge of the mask pattern, and the scanning of the plurality of lines is performed one after another from the mask pattern side towards a tip side of the defect portion, and

at the processing step, the scanning for every one line is performed in the parallel direction to the edge of the mask pattern, and the scanning of the plurality of lines is performed one after another from the tip side of the defect portion towards the mask pattern.

In the photomask defect correction device and the photomask defect correction method according to the present invention, first, a photomask having a mask pattern drawn in advance on the substrate with a predetermined pattern is fixed on the stage. After fixing the photomask, a periphery of the projection type of the defect portion of the mask pattern which is specified its position by other means may be specified as an observation area.

If the observation area is specified, the control means scans the probe within the observation area to obtain an image through AFM observation, and performs the observation step for recognizing the shape of the defect portion in detail. Specifically, the scanning is performed for the multiple lines one after another, while controlling the distance between the probe tip and the substrate surface, so that the displacement of the probe becomes constant, to thereby obtain the observation image. With this operation, it is possible to conduct the observation of the surface of the substrate within the specified observation area, thereby being capable of recognizing a part of the mask pattern and the contour shape of the defect portion.

In particular, when repeatedly performing the scanning for every one line to scan the multiple lines one after another, the control is performed so that the repeating direction (namely, direction of transferring the probe to the adjacent line) is from the root side of the defect portion being the mask pattern side towards the tip side of the defect portion. Specifically, not conducting the observation of the tip end side of the defect portion first, the observation from the root side is performed first. Accordingly, using a clean probe tip to which no foreign matter is attached, it is possible to first observe the periphery of the root side of the defect portion, thereby being capable of correctly obtaining contour shape of the periphery of the root side of the defect portion and an image of the edge shape of the mask pattern without being influenced by the double chip image. With this operation, the observation may be made with a state in which the defect portion and the mask pattern are clearly distinguished.

Note that, after the observation of the root side of the defect portion, the scanning is repeated towards the tip end side of the defect portion gradually, but on the way, a part of the defect portion scooped by the probe tip may attach to the probe. In this case, the image of the defect portion on the tip end side becomes a double chip image, thereby being not possible to recognize the contour shape on the tip end side. However, as the root side of the defect portion is first observed as described above, it is possible to obtain correct image with respect to the periphery of the root side.

Moreover, regarding the scanning for every line, the probe is scanned in a direction parallel to the edge of the mask pattern. Owing to this, the scanning may be made along the edge of the mask pattern, thereby being capable of obtaining the image of the edge with high accuracy. As a result, the edge of the mask pattern may be clearly recognized.

Subsequently, the control means performs the processing step of conducting the cutting and removing processing of the defect portion by scanning the adjacent multiple lines one after another while pressing the probe tip with a predetermined force to the defect portion whose shape is recognized in detail through the observation step. Specifically, different from the above-mentioned observation step, the control is performed so that the repeating direction for scanning the multiple lines one after another (namely, direction for transferring the probe to the adjacent line) moves from the tip end side of the defect portion towards the mask patter being the root side of the defect portion. As described above, the cutting and removing processing is performed from the tip end side of the defect portion, the processing may be made with small cutting resistance, thereby being capable of cutting with efficiently and short period of time.

As described above, according to the photomask defect correction device and the photomask defect correction method, through the observation step, images of the contour shape of the root side of the defect portion and the edge of the mask pattern may be correctly obtained different from the conventional ones so that the defect portion and the mask patter are clearly distinguished therebetween. Owing to this, while preventing the problem of cutting the mask pattern from occurring, the defect portion may only be removed by subjecting the defect portion to the cutting and removing processing with high accuracy.

As a result, the correction of the mask pattern may be made with high accuracy. In addition, there may be obtained a high quality photo mask as an original plate for the transfer.

Further, according to the present invention, there is provided a photomask defect correction device for correcting a defect on a photomask including a substrate and a mask pattern formed on the substrate with a predetermined pattern through AFM observation of the photomask to recognize a shape of a projection type defect portion projected from the mask pattern, and by cutting and removing processing the recognized defect portion,

the photomask defect correction device including:

a stage for fixing the photomask;
a probe having a probe tip provided on a tip of the probe, the probe tip being disposed opposingly to the substrate;
a moving means for relatively moving the substrate and the probe in a parallel direction of a surface of the substrate and in a vertical direction the surface of the substrate;
a displacement measuring means for measuring displacement of the probe; and
a control means for scanning, based on results of measurement by the displacement measuring mean, adjacent plurality of lines one after another so that the displacement of the probe becomes constant, while controlling a distance between the probe tip and a surface of the substrate, recognizing a shape of the defect portion through AFM observation, and for cutting and removing processing the defect portion by scanning the adjacent plurality of lines one after another while pressing the probe tip to the recognized defect portion with a predetermined force, to thereby subject the defect portion to the cutting and removing processing,

in which the control means sets, at the time of observation, the scanning direction for every one line in a direction from the mask pattern side towards a tip side of the defect portion with respect to an edge of the mask pattern, and controls so that the scanning of the plurality of lines one after another is performed in a direction parallel to the edge of the mask pattern from the mask pattern side, and

the control means sets, at the time of cutting and removing processing, the scanning direction for the every one line in the parallel direction with respect to the edge of the mask pattern, and controls so that the scanning of the plurality of lines one after another is performed in a direction from the tip of the defect portion towards the mask pattern.

Further, according to the present invention, there is provided a photomask defect correction method of correcting a defect on a photomask including a substrate and a mask pattern formed on the substrate with a predetermined pattern by recognizing a shape of a projection type defect portion projected from the mask pattern through AFM observation of the photomask by using a probe having a probe tip at a tip of the probe and by cutting and removing processing the recognized defect portion using the probe,

the photomask defect correction method including:
an observing step of scanning adjacent plurality of lines one after another while controlling a distance between the probe tip and a surface of the substrate so that displacement of the probe becomes constant to recognize a shape of the defect portion through AFM observation; and
a processing step of, after the observing step, scanning the adjacent plurality of lines one after another while pressing the probe tip to the recognized defect portion with a predetermined force to subject the defect portion to cutting and removing processing,

in which, at the observing step, the scanning for every one line is performed in a direction from the mask pattern side towards a tip of the defect portion, and the scanning of the plurality of lines is performed one after another in a parallel direction to an edge of the mask pattern, and

at the processing step, the scanning for every one line is performed in the parallel direction to the edge of the mask pattern, and the scanning of the plurality of lines is performed one after another from the tip of the defect portion towards the mask pattern.

In the photomask defect correction device and the photomask defect correction method according to the present invention, first, a photomask having a mask pattern drawn in advance on the substrate with a predetermined pattern is fixed on the stage. After fixing the photomask, a periphery of the projection type of the defect portion of the mask pattern which is specified its position by other means may be specified as an observation area.

If the observation area is specified, the control means scans the probe within the observation area to obtain an image through AFM observation, and performs the observation step for recognizing the shape of the defect portion in detail. Specifically, the scanning is performed for the multiple lines one after another, while controlling the distance between the probe tip and the substrate surface, so that the displacement of the probe becomes constant, to thereby obtain the observation image. With this operation, it is possible to conduct the observation of the surface of the substrate within the specified observation area, thereby being capable of recognizing a part of the mask pattern and the contour shape of the defect portion.

In particular, the scanning for every one line is performed from the mask pattern side towards the tip side of the defect portion. As described above, when the scanning for every one line is performed, the scanning is performed from the mask pattern side formed on the substrate, and hence the probe tip always goes down the step generated between the probe tip and the substrate from the upstage towards the down stage. In this case, the phenomenon in which the defect portion is scooped by the probe tip, and a part thereof attaches to the probe tip is liable to occur when the probe tip runs up the defect portion. However, by scanning the probe tip in the above-mentioned direction, the run up of the probe tip may be reduced, thereby being capable of preventing the defect portion from being scooped by the probe tip.

Accordingly, there may be obtained the observation using a clean probe tip to which no foreign matter is attached, it is possible to correctly obtain the image not only of the root side of the defect portion, but also the images of the entire contour shape and the edge shape of the mask pattern without being influenced by the double chip image. With this operation, the observation may be made with a state in which the defect portion and the mask pattern are clearly distinguished

Moreover, when the scanning for every one line is repeatedly performed to scan the multiple lines one after another, the repeating direction (namely, direction for transferring the probe to the adjacent line) is controlled so that the repeating direction becomes a parallel direction to the edge of the mask pattern. Thus, even if the number of times for scanning is reduced, it is possible to detect the edge from the observation image obtained by each scanning, thereby being capable of reducing a period of time consuming the observation step to enhance the work efficiency.

Subsequently, the control means performs the processing step of conducting the cutting and removing processing of the defect portion by scanning the adjacent multiple lines one after another while pressing the probe tip with a predetermined force to the defect portion whose shape is recognized in detail through the observation step. Specifically, different from the above-mentioned observation step, the control is performed so that the repeating direction for scanning the multiple lines one after another (namely, direction for transferring the probe to the adjacent line) moves from the tip end side of the defect portion towards the mask patter being the root side of the defect portion. As described above, the cutting and removing processing is performed from the tip end side of the defect portion, the processing may be made with small cutting resistance, thereby being capable of cutting with efficiently and short period of time.

As described above, according to the photomask defect correction device and the photomask defect correction method, through the observation step, images of the contour shape of the root side of the defect portion and the edge of the mask pattern may be correctly obtained different from the conventional ones so that the defect portion and the mask patter are clearly distinguished therebetween. Owing to this, while preventing the problem of cutting the mask pattern from occurring, the defect portion may only be removed by subjecting the defect portion to the cutting and removing processing with high accuracy.

As a result, the correction of the mask pattern may be made with high accuracy. In addition, there may be obtained a high quality photo mask as an original plate for the transfer.

The photomask defect correction device and the photomask defect correction method with which it is possible to correctly obtain an image in a periphery on a root side of a defect portion without receiving an influence of a double chip image to recognize the defect portion and the mask pattern with clearly distinguished state, and is possible to remove the defect portion with high accuracy by means of cutting and removing processing. As a result, the mask pattern may be corrected with high accuracy.

### BRIEF DESCRIPTION OF THE DRAWINGS

In the accompanying drawings:

FIG. 1 is a perspective view of a photomask to which correction is performed by a photomask defect correction device according to the present invention;

FIG. 2 is a block diagram illustrating a photomask defect correction device according to an embodiment of the present invention;

FIG. 3 illustrates one process for correcting a defect portion produced on a mask pattern by the photomask defect correction device of FIG. 2, in which movement of a probe when AFM observation is performed within a set observation area is viewed from upward of a mask pattern;

FIG. 4 is a sectional view taken along an arrow G-G of FIG. 3;

FIG. 5 is an image view of the mask pattern and the defect portion, which are obtained by the observation illustrated in FIG. 3;

FIG. 6 illustrates one process for correcting the defect portion produced on a mask pattern by the photomask defect correction device of FIG. 2, in which movement of the probe when the defect portion is subjected to cutting and removing processing after completing the observation is viewed from upward of the mask pattern;

FIG. 7 is a sectional view taken along an arrow H-H of FIG. 6;

FIG. 8 is a perspective view illustrating the mask pattern after conducting the cutting and removing processing;

FIG. 9 illustrates a modification example of the present invention when conducting AFM observation, in which movement of the probe which is scanned in a direction opposite to the direction illustrated in FIG. 3 is viewed from the upward of the mask pattern;

FIG. 10 illustrates a modification example of the present invention, in which the movement of the probe which is scanned from the mask pattern side towards a tip side of a defect portion and the scanning is repeatedly performed in a parallel direction to the mask pattern is viewed from the upward of the mask pattern;

FIG. 11 illustrates a modification example of the present invention, in which the movement of the probe which is scanned in a direction opposite to the direction illustrated in FIG. 10 is viewed from the upward of the mask patter;

FIG. 12 illustrates a conventional method of correcting the mask, in which, when conducting AMF observation, movement of a probe which is scanned in a parallel direction to a mask pattern and the scanning is repeatedly performed from a tip side of a defect portion towards the mask pattern side is viewed from the upward of the mask pattern;

FIG. 13 illustrates a state in which a foreign matter is attached to the probe when conducting the observation illustrated in FIG. 12;

FIG. 14 illustrates a state in which another foreign matter is further attached to the probe after the state illustrated in FIG. 13;

FIG. 15 is an image view of the mask pattern and the defect portion, which are obtained by the probe illustrated in FIG. 13; and

FIG. 16 is a sectional view taken along an arrow A-A of FIG. 15.

### DETAILED DESCRIPTION OF THE PREFERRED EMBODIMENTS

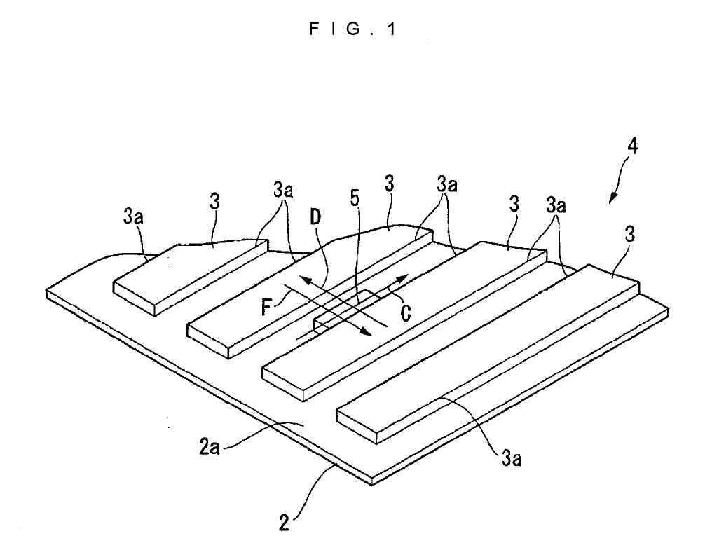

Hereinafter, description is made of an embodiment of a photomask defect correction device and a photomask defect correction method according to the present invention with reference to FIG. 1 to FIG. 8. Note that, in this embodiment, description is made of a case as an example where an optical lever method is used.

The photomask defect correction device 1 according to this embodiment performs AFM observation of a photomask 4 shown in FIG. 1, which includes a substrate 2 and a light-blocking film mask pattern (hereinafter, simply referred to as mask pattern) 3 formed on the substrate 2 so as to have a given pattern, a projection type of an excessive defect portion 5 (hereinafter, simply referred to as defect portion) projected from the mask pattern 3 is subjected to AFM observation to recognize a shape of the defect portion, and then the defect portion 5 is subjected to cutting and removing processing, to thereby correct the recognized defect portion 5.

Note that, the photomask 4 is prepared by a drawing device (not shown), and the mask pattern 3 is drawn on the substrate 2 based on drawing data designed in advance. Further, the photomask 4 is inspected with a defect inspection device (not shown) after being prepared by the drawing device, and hence a position of the defect portion 5 has already been specified. Further, the substrate 2 of the photomask 4 is an optical transmitting portion and becomes a mask substrate, and is, for example, a glass or quartz substrate.

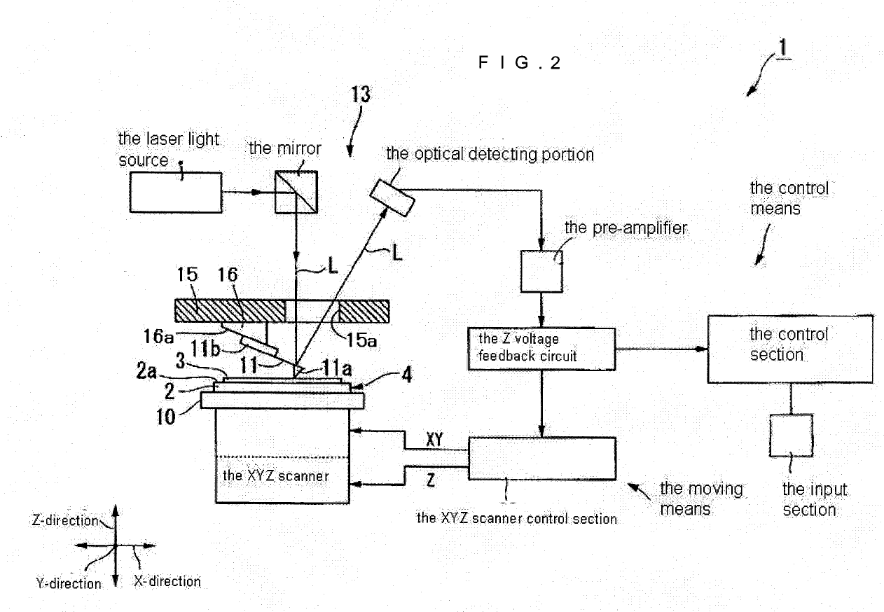

The photomask defect correction device 1 of this embodiment, as illustrated in FIG. 2, includes a stage 10 for fixing the photomask 4, a probe 11 having at a tip thereof a probe tip 11a provided so as to oppose to the substrate 2, a moving means for relatively moving the substrate 2 and the probe tip 11a in an XY direction which is parallel to the substrate surface 2a and in a Z direction which is perpendicular to the substrate surface 2a, a displacement measuring means 13 for measuring a displacement of the probe 11 (deformation), and a control means 14 for totally controlling the respective components.

The probe tip 11a is made of a hard material such as a diamond so that the defect portion 5 is easily cut away, and is formed so that a surface that abuts against the defect portion 5 at the cutting and removing processing forms a right angle (perpendicular) to the defect portion 5. Further, the probe 11 is made of silicon or the like, and is supported in a cantilever state by a body portion 11b. The probe having a higher spring constant than the conventional one is used for the probe 11 so as to prevent a sufficient load necessary for processing from not being applied to an edge, which undergoes distortion due to processing resistance at the time of the cutting processing. The body portion 11b is detachably fixed using a wire or the like (not shown) to a mounting surface 16a of a slanted block 16 which is fixed to a holder portion 15. With this structure, the probe 11 is fixed while being inclined by a predetermined angle with respect to the substrate surface 2a.

The holder portion 15 is mounted to a frame (not shown) so as to be positioned upward of the substrate 2. Further, the holder portion 15 has an opening 15a formed therein, which allows a laser light L described later to enter into a reflecting surface (not shown) formed on a back surface the probe 11 and also allows the laser light L reflected on the reflecting surface to exit.

The stage 10 is mounted on the XYZ scanner 20, and the XYZ scanner 20 is mounted on a vibration-isolated table (not shown). The XYZ scanner 20 is, for example, a piezoelectric element, and is configured to minutely move in an XY direction and in a Z direction by being applied with a voltage from an XYZ scanner control section 21 including an XY scanning system and a z servo system. Specifically, the XYZ scanner 20 and the XYZ scanner control section 21 each function as the above-mentioned moving means 12.

Further, provided above the holder portion 15 are a laser light source 22 which emits the laser light L towards the reflecting surface formed on the back surface of the probe 11, and a optical detecting portion 24 which receives the laser light L reflected on the reflecting surface using a mirror 23. Note that, the laser light L emitted from the laser light source 22 passes through the opening 15a of the holder portion 15 to reach to the reflecting surface, and after being reflected on the reflecting surface, the laser light L enters the optical detecting portion 24 by passing through the opening 15a again.

The optical detecting portion 24 is, for example, a photodiode having an incident surface which is divided into two or four, and detects the displacement (deformation) of the probe 11 judging from an incident position of the laser light L. Then, the optical detecting portion 24 outputs the detected displacement of the probe 11 as a DIF signal to the pre-amplifier 25. Specifically, the laser light source 22, the mirror 23, and the optical detecting portion 24 each function as the displacement measuring means 13 for measuring the displacement of the probe 11.

Further, the DIF signal output from the optical detecting portion 24 is amplified by the pre-amplifier 25, and then transmitted to a Z voltage feedback circuit 26. The Z voltage feedback circuit 26 performs a feedback control of the XYZ scanner control section 21 so that the transmitted DIF signal becomes always constant. With this structure, when the substrate surface 2a is subjected to AFM observation, the distance (height) between the substrate 2 and the probe tip 11a may be controlled so that the displacement of the probe 11 becomes constant.

Further, the control section 27 is connected to the Z voltage feedback circuit 26, and the control section 27 is configured so as to obtain the observation data on the substrate surface 2a based on a signal for vertical movements from the Z voltage feedback circuit 26. With this structure, the mask pattern 3 formed on the substrate 2 and an image of the defect portion 5 of the mask pattern 3 may be obtained.

Specifically, the Z voltage feedback circuit 26 and the control section 27 each function as the control means 14. Note that, the control means 14 is set so as to perform AFM observation to recognize in detail the defect portion 5 being an object of the cutting and removing processing, and thereafter subsequently, to perform the cutting and removing processing of the defect portion 5.

Further, an input section 28 through which an operator may input various information is connected to the control section 27, thereby being capable of freely setting the observation area, etc. for conducting AFM observation through the input section 28. With this structure, the operator may set the observation area E based on a rough positional data of the defect portion 5 identified by the defect inspection device. Then, the control section 27 is set so as to perform AFM observation and the cutting and removing processing within the observation area E, if the observation area E is set.

In this embodiment, the control means 14 controls the respective components so that, when conducting AFM observation, the scanning is performed for the adjacent multiple lines one after another so that the displacement of the probe 11 becomes constant while controlling the distance between the probe tip 11a and the substrate surface 2a to conduct AFM observation.

Specifically, as illustrated in FIG. 1, the scanning direction for every one line is set to a direction parallel to the edge 3a of the mask pattern 3 (arrow C direction), and is controlled so that the scanning is performed for the multiple lines one after another in a direction from the mask pattern 3 side towards the tip of the defect portion 5 (arrow D direction).

On the other hand, when performing the cutting and removing processing, the control means 14 controls the respective components so that the scanning is performed for the adjacent multiple lines one after another while pressing the probe tip 11a with a predetermined force to the defect portion 5 recognized through the AFM observation to subject the defect portion 5 to the cutting and removing processing.

Specifically, as illustrated in FIG. 1, the scanning direction for every one line is set to a direction parallel to the edge 3a of the mask pattern 3 (arrow C direction), and the scanning is controlled so as to scan the multiple lines one after another from the tip side of the defect portion 5 towards the mask pattern 3 (arrow F direction)

Next, description is made of the photomask defect correction method for correcting the defect portion of the mask pattern 3 using thus constructed photomask defect correction device 1, hereinbelow.

The photomask defect correction method according to this embodiment includes: an observation step of recognizing in detail the shape of the defect portion 5 specified by the defect inspection device through AFM observation; and a processing step of cutting and removing processing the defect portion 5 recognized by the observation step to remove the defect portion 5. Those respective steps are described hereinbelow in detail.

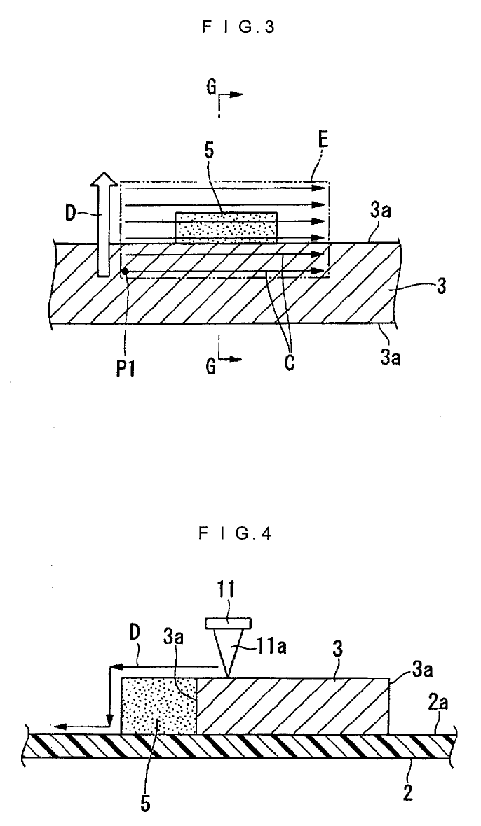

First, an initial setting is performed. Specifically, after fixing a photomask 4 on a stage 10, positions of a laser light source 22 and a optical detecting portion 24, a mounting state of a probe 11, and the like are adjusted so that a laser light L positively enters a reflecting surface of the probe 11, and further, the reflected laser light L positively enters the optical detecting portion 24. Subsequently, an operator specifies as an observation area E, as illustrated in FIG. 3, through an input section 28, a periphery of the defect portion 5 whose position is identified by the defect inspection device.

After completing the initial setting, observation is started.

When the observation is started, the control means 14 causes the probe 11 to conduct scanning within the specified observation area E to obtain an observation image through AFM observation, and performs the observation step for recognizing the shape of the defect portion 5 in detail. Specifically describing, first, an XYZ scanner 20 is driven to move the probe tip 11a to a point P1 shown in FIG. 3. At the point P1, the probe tip 11a and the substrate 2 are allowed to approach each other, and the probe tip 11a and the mask pattern 3 are brought into contact with each other with a minute force. At this time, as the probe tip 11a approaches to the mask pattern 3, the probe 11 gradually bends to be displaced. Thus, based on this displacement, detection may be made with high precision as to whether or not the probe tip 11a is brought into contact with the mask pattern 3 with a minute force.

Subsequently, the XYZ scanner 20 is driven to allow the probe tip 11a to scan in a parallel direction (arrow C direction) with respect to the edge 3a of the mask pattern 3, while controlling the height of the XYZ scanner 20 so that the displacement of the probe 11 becomes constant, and the scanning is performed repeatedly in multiple times in a direction from a tip side of the defect portion 5 towards the mask pattern 3 (arrow D direction). At this time, depending on irregularities, the probe 11 tends to bend and displace. Accordingly, the position of the incident laser light L entering the optical detecting portion 24 differs. Then, the optical detecting portion 24 outputs a DIF signal in accordance with displacement of the incident position to a pre-amplifier 25. The output DIF signal is amplified by the pre-amplifier 25, and then transmitted to the Z voltage feedback circuit 26.

The Z voltage feedback circuit 26 minutely moves the XYZ scanner 20 in a Z direction by the XYZ scanner control section 21 so that the DIF signal transmitted becomes constant (that is, the displacement of the probe 11 becomes constant), to thereby conduct a feedback control. With this operation, the scanning may be carried out with a state in which the height of the XYZ scanner 20 is controlled so that the displacement of the probe 11 becomes constant. Further, the control section 27 may conduct the surface observation within the observation area E based on a signal for vertically moving the XYZ scanner 20 by the Z voltage feedback circuit 26. As a result, within the observation area E, the contour shapes of parts of the mask pattern 3 and the defect portion 5 may be recognized.

In particular, when repeatedly performing the scanning for every one line to scan the multiple lines one after another, the control is performed so that the repeating direction (namely, direction of transferring the probe to the adjacent line) is from the root side of the defect portion being the mask pattern side towards the tip side of the defect portion. Specifically, not conducting the observation of the tip end side of the defect portion first, the observation from the root side is performed first. Accordingly, using a clean probe tip 11a to which no foreign matter is attached, it is possible to first observe the periphery of the root side of the defect portion 5, thereby, as illustrated in FIG. 5, being capable of correctly obtaining contour shape of the periphery of the root side of the defect portion and an image of the edge shape of the mask pattern without being influenced by the double chip image. With this operation, the observation may be made with a state in which the defect portion and the mask pattern are clearly distinguished.

Note that, after the observation of the root side of the defect portion 5, the scanning is repeated towards the tip end side of the defect portion 5 gradually, but on the way, a part of the defect portion 5 scooped by the probe tip 11a may attach to the probe tip 11a. In this case, the image of the defect portion 5 on the tip end side becomes a double chip image, thereby being not possible to recognize the contour shape on the tip end side. However, as the root side of the defect portion is first observed as described above, as illustrated in FIG. 5, it is possible to obtain correct image with respect to the periphery of the root side.

Moreover, regarding the scanning for every line, the probe tip 11a is scanned in a direction parallel to the edge of the mask pattern. With this structure, the scanning may be made along the edge 3a of the mask pattern 3, thereby being capable of obtaining the image of the edge 3a with high accuracy. Owing to this, the edge 3a of the mask pattern 3 may be clearly recognized.

Subsequently, the control section 27 performs the processing step of conducting the cutting and removing processing of the defect portion 5 by scanning the adjacent multiple lines one after another while pressing the probe tip 11a with a predetermined force to the defect portion 5 whose shape is recognized in detail through the observation step.

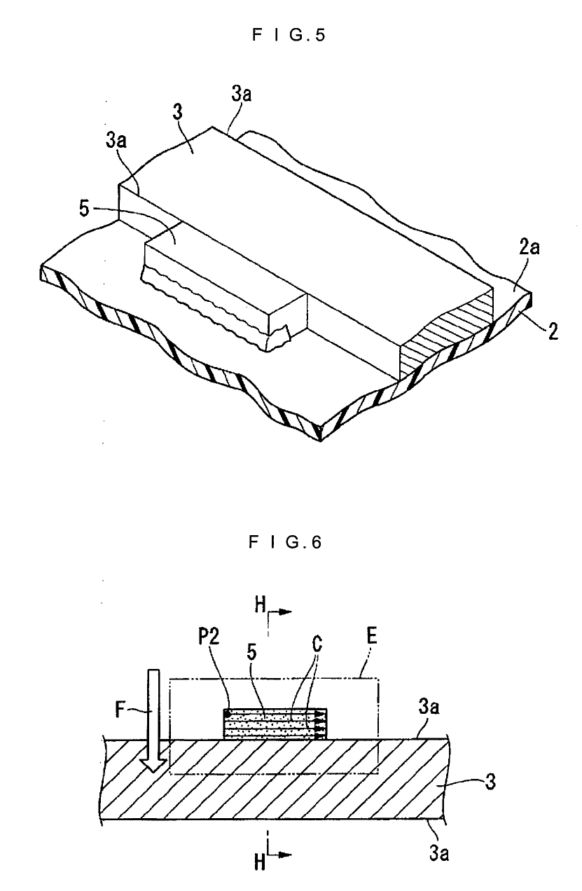

Specifically describing, first, an XYZ scanner 20 is driven to move the probe tip 11a to a point P2 shown in FIG. 6. At the point P2, the probe tip 11a and the substrate 2 are allowed to approach each other, and the probe tip 11a and the mask pattern 3 are brought into contact with each other with a minute force. At this time, as pressing the probe tip 11a, the probe 11 gradually bends to be displaced. Thus, based on this displacement, the probe tip 11a may be positively pressed with a predetermined force.

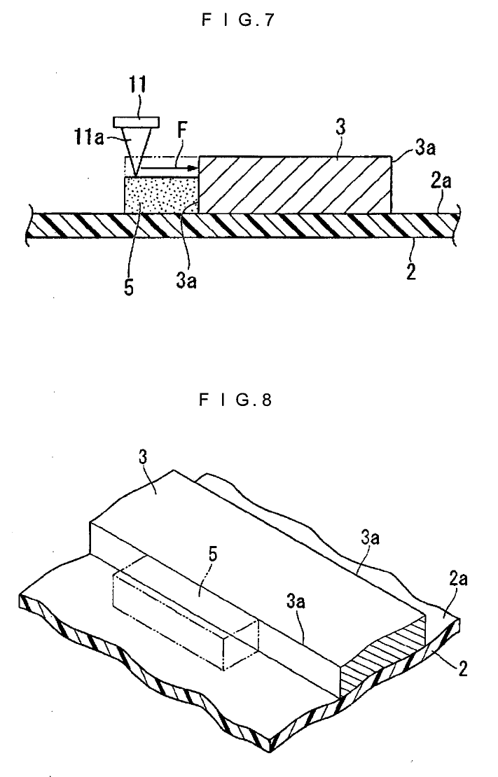

Subsequently, while controlling the pressing force, the XYZ scanner 20 is driven to scan the probe tip 11a in a parallel direction to the edges 3a of the mask pattern 3 (arrow C direction) in linear, and as illustrated in FIG. 6 and FIG. 7, the linear scanning is repeatedly performed one after another in a direction from the tip of the defect portion 5 towards the mask pattern 3 side (arrow F direction). With this operation, the defect portion 5 may be cut and removed gradually, and finally, the entire defect portion 5 may be cut and removed. In particular, different from the above-mentioned observation step, the cutting and removing processing is performed from the tip of the defect portion 5, the processing may be performed with small cutting resistance, thereby being capable of efficiently conducting the cutting with a short period of time.

Further, through the observation step, images of the contour shape of the root side of the defect portion 5 and the edge 3a of the mask pattern 3 may be correctly obtained different from the conventional ones so that the defect portion 5 and the mask pattern 3 are clearly distinguished therebetween. With this structure, while preventing the problem of cutting the mask pattern from occurring, as illustrated in FIG. 8, the defect portion 5 may only be removed by subjecting the defect portion 5 to the cutting and removing processing with high accuracy. As a result, the correction of the mask pattern 3 may correctly be made with high accuracy. In addition, a high quality photomask 4 may be obtained as an original plate for the transfer.

As described above, according to the photomask defect correction device 1 and the photomask defect correction method of this embodiment, at the time of the observation, it is possible to correctly obtain an image of the periphery of the root side of the defect portion 5 without being influenced by the double chip image, thereby being capable of the recognition may be made with a state in which the defect portion 5 and the mask pattern 3 are clearly distinguished. As a result, the defect portion 5 may only be removed by subjecting the defect portion 5 to the cutting and removing processing with high accuracy, thereby being capable of conducting the correction with high accuracy.

Note that, a technical scope of the present invention is not limited to the above-mentioned embodiment, and various modifications may be made without departing from the purpose and the scope of the present invention.

For example, in the above-mentioned embodiment, the scanning method is employed in which the substrate 2 side is moved in a three-dimensional direction, but is not limited to the above-mentioned case, the probe 11 side may be moved in the three-dimensional direction. Further, there may employ a structure in which the prove 11 side is moved in a Z direction and the substrate 2 side is moved in an XY direction. Even in either case, only the scanning method differs, thereby being capable of taking the same operational effect as that of the above-mentioned embodiment.

Further, in the above-mentioned embodiment, it employs a structure in which, through the opening 15a formed in the holder portion 15, the laser light L is allowed to enter into the prove 11, and the reflected laser light L is allowed to outgo, but is not limited to this case. For example, the holder portion 15 may be made of a material which is optically transparent (for example, glass), and the opening 15a may be omitted.

Further, in the above-mentioned embodiment, the displacement measuring means 13 detects the displacement of the prove 11 using an optical lever method, it is not limited to the optical lever method, for example, there may employ a self detection method in which the prove 11 itself includes a displacement detection function (for example, piezoelectric resistance element).

Further, in the above-mentioned embodiment, the scanning may be performed in an arrow J direction (direction opposite to arrow C direction) at the observation step. In this case, too, the same operational effect may be attained.

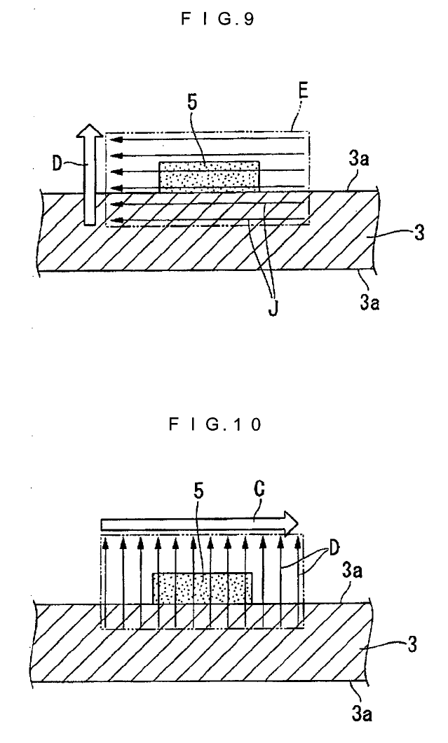

In addition, in the above-mentioned embodiment, at the observation step, the scanning direction for every one line is set to a direction parallel to the edge 3a of the mask pattern 3 (arrow C direction), and control is performed so that the scanning is performed for the multiple lines one after another in a direction from the mask pattern side to the tip of the defect portion 5 (arrow D direction). However, the control may be made as illustrated in FIG. 10.

Specifically, the control is performed so that the scanning is linearly performed from the mask pattern side 3 towards the defect portion 5 (arrow D direction), and the linear scanning may be performed one after another in a parallel direction to the edge 3a of the mask pattern 3 (arrow C direction).

In this case, when the scanning for every one line is performed, the scanning is performed from the mask pattern 3 side formed on the substrate 2, and hence the probe tip 11a always goes down the step generated between the substrate 2 and the mask pattern 3 or the defect portion 5 from the upstage towards the down stage. In this case, the phenomenon in which the defect portion 5 is scooped by the probe tip 11a, and a part thereof attaches to the probe tip 11a is liable to occur when the probe tip runs up the defect portion. However, by scanning the probe tip 11a in the above-mentioned direction (D direction), the run up of the probe tip 11a may be reduced, thereby being capable of preventing the defect portion 5 from being scooped by the probe tip 11a.

Consequently, there may be obtained the observation using a clean probe tip 11a to which no foreign matter is attached, it is possible to correctly obtain the image not only of the root 5 side of the defect portion, but also the images of the entire contour shape and the edge 3a shape of the mask pattern 3 without being influenced by the double chip image. As a result, as in the above-mentioned embodiment, the cutting of the defect portion 5 may be performed with high accuracy, and the correction of the mask pattern 3 may be positively carried out.

Moreover, the scanning is repeatedly performed in a parallel direction to the edge 3a of the mask pattern 3 (arrow C direction). Thus, even if the number of times for scanning is reduced, it is possible to detect the edge 3a from the observation image obtained by each scanning, thereby being capable of reducing a period of time consuming the observation step to enhance the work efficiency.

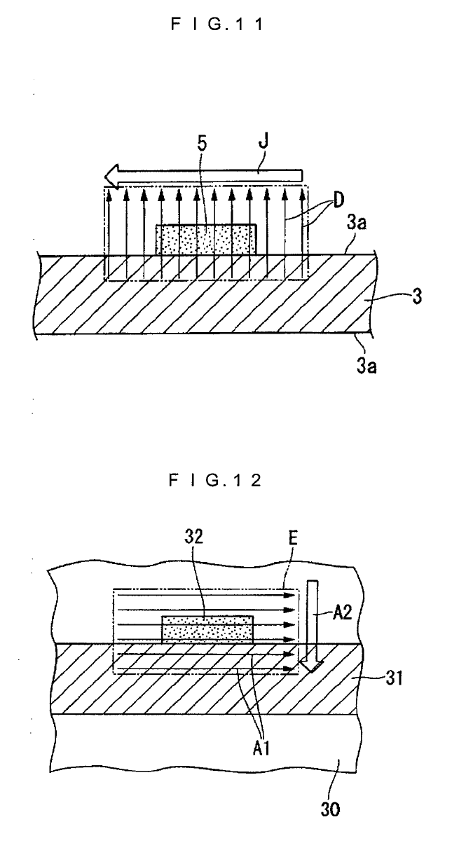

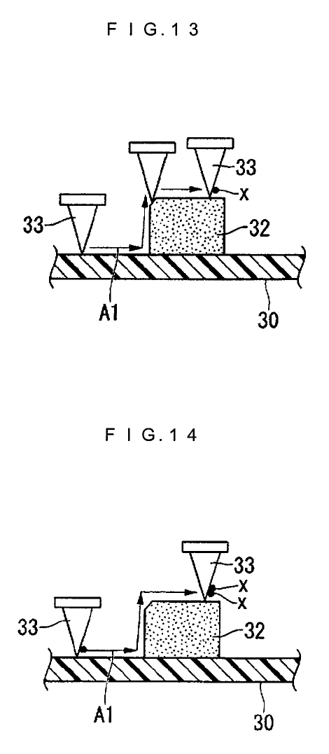

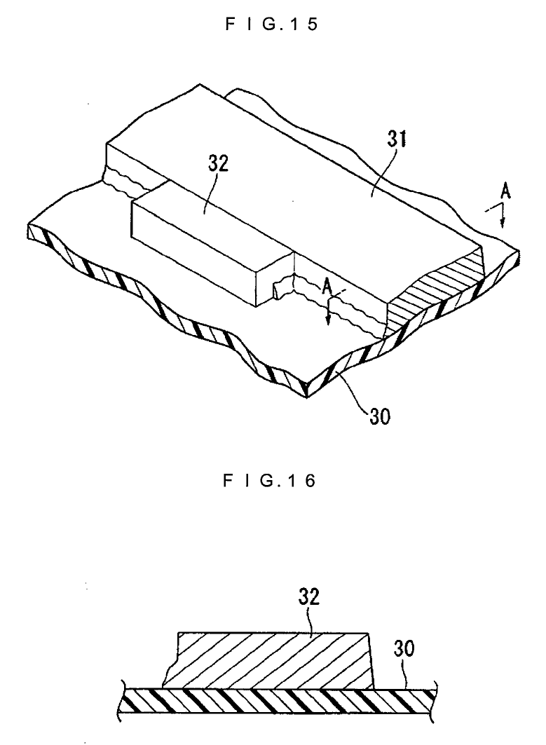

Note that, the linear scanning may be repeatedly one after another in an arrow J direction as illustrated in FIG. 11. In this case, too, the same operational effect may be attained.

What is claimed is:

1. A photomask defect correction device for correcting a defect on a photomask including a substrate and a mask pattern formed on the substrate with a predetermined pattern through AFM observation of the photomask to recognize a shape of a projection type defect portion projected from the mask pattern, and by cutting and removing processing the recognized defect portion,
the photomask defect correction device comprising:
a stage for fixing the photomask;
a probe having a probe tip provided on a tip of the probe, the probe tip being disposed opposingly to the substrate;
a moving means for relatively moving the substrate and the probe in a parallel direction of a surface of the substrate and in a vertical direction the surface of the substrate;
a displacement measuring means for measuring displacement of the probe; and
a control means for scanning, based on results of measurement by the displacement measuring mean, adjacent plurality of lines one after another so that the displacement of the probe becomes constant, while controlling a distance between the probe tip and a surface of the substrate, recognizing a shape of the defect portion through AFM observation, and for cutting and removing processing the defect portion by scanning the adjacent plurality of lines one after another while pressing the probe tip to the recognized defect portion with a predetermined force, to thereby subject the defect portion to the cutting and removing processing,
wherein the control means sets, at the time of observation, the scanning direction for every one line in a parallel direction with respect to an edge of the mask pattern, and controls so that the scanning of the plurality of lines one after another is performed in a direction from the mask pattern side towards a tip side of the defect portion, and
the control means sets, at the time of cutting and removing processing, the scanning direction for the every one line in the parallel direction with respect to the edge of the mask pattern, and controls so that the scanning of the plurality of lines one after another is performed in a direction from the tip of the defect portion towards the mask pattern.

2. A photomask defect correction device for correcting a defect on a photomask including a substrate and a mask pattern formed on the substrate with a predetermined pattern through AFM observation of the photomask to recognize a shape of a projection type defect portion projected from the mask pattern, and by cutting and removing processing the recognized defect portion,
the photomask defect correction device comprising:
a stage for fixing the photomask;
a probe having a probe tip provided on a tip of the probe, the probe tip being disposed opposingly to the substrate;
a moving means for relatively moving the substrate and the probe in a parallel direction of a surface of the substrate and in a vertical direction the surface of the substrate;
a displacement measuring means for measuring displacement of the probe; and
a control means for scanning, based on results of measurement by the displacement measuring mean, adjacent plurality of lines one after another so that the displacement of the probe becomes constant, while controlling a distance between the probe tip and a surface of the substrate, recognizing a shape of the defect portion through AFM observation, and for cutting and removing processing the defect portion by scanning the adjacent plurality of lines one after another while pressing the probe tip to the recognized defect portion with a predetermined force, to thereby subject the defect portion to the cutting and removing processing,
wherein the control means sets, at the time of observation, the scanning direction for every one line in a direction from the mask pattern side towards a tip side of the defect portion with respect to an edge of the mask pattern, and controls so that the scanning of the plurality of lines one after another is performed in a direction parallel to the edge of the mask pattern from the mask pattern side, and
the control means sets, at the time of cutting and removing processing, the scanning direction for the every one line in the parallel direction with respect to the edge of the mask pattern, and controls so that the scanning of the plurality of lines one after another is performed in a direction from the tip of the defect portion towards the mask pattern.

3. A photomask defect correction method of correcting a defect on a photomask including a substrate and a mask pattern formed on the substrate with a predetermined pattern by recognizing a shape of a projection type defect portion projected from the mask pattern through AFM observation of the photomask by using a probe having a probe tip at a tip of the probe and by cutting and removing processing the recognized defect portion using the probe,
the photomask defect correction method comprising:
an observing step of scanning adjacent plurality of lines one after another while controlling a distance between the probe tip and a surface of the substrate so that displacement of the probe becomes constant to recognize a shape of the defect portion through AFM observation; and
a processing step of; after the observing step, scanning the adjacent plurality of lines one after another while pressing the probe tip to the recognized defect portion with a predetermined force to subject the defect portion to cutting and removing processing,
wherein, at the observing step, the scanning for every one line is performed in a parallel direction to an edge of the mask pattern, and the scanning of the plurality of lines is performed one after another from the mask pattern side towards a tip side of the defect portion, and
at the processing step, the scanning for every one line is performed in the parallel direction to the edge of the mask pattern, and the scanning of the plurality of lines is performed one after another from the tip side of the defect portion towards the mask pattern.

4. A photomask defect correction method of correcting a defect on a photomask including a substrate and a mask pattern formed on the substrate with a predetermined pattern by recognizing a shape of a projection type defect portion projected from the mask pattern through AFM observation of the photomask by using a probe having a probe tip at a tip of the probe and by cutting and removing processing the recognized defect portion using the probe,
the photomask defect correction method comprising:
an observing step of scanning adjacent plurality of lines one after another while controlling a distance between the probe tip and a surface of the substrate so that displacement of the probe becomes constant to recognize a shape of the defect portion through AFM observation; and
a processing step of, after the observing step, scanning the adjacent plurality of lines one after another while pressing the probe tip to the recognized defect portion with a predetermined force to subject the defect portion to cutting and removing processing,
wherein, at the observing step, the scanning for every one line is performed in a direction from the mask pattern side towards a tip of the defect portion, and the scanning of the plurality of lines is performed one after another in a parallel direction to an edge of the mask pattern, and
at the processing step, the scanning for every one line is performed in the parallel direction to the edge of the mask pattern, and the scanning of the plurality of lines is performed one after another from the tip of the defect portion towards the mask pattern.
